(19) United States
(12) Patent Application Publication
(10) Pub. No.: US 2021/0389539 A1
(43) Pub. Date: Dec. 16, 2021

(54) OPTICAL-FIBER-CABLE WINDING BOBBIN

(71) Applicant: SUMITOMO ELECTRIC INDUSTRIES, LTD., Osaka-shi, Osaka (JP)

(72) Inventors: Keigo YAMAMOTO, Osaka-shi, Osaka (JP); Kentaro TAKEDA, Osaka-shi, Osaka (JP); Shinji EGAWA, Osaka-shi, Osaka (JP)

(73) Assignee: SUMITOMO ELECTRIC INDUSTRIES, LTD., Osaka-shi, Osaka (JP)

(21) Appl. No.: 17/288,247

(22) PCT Filed: Oct. 24, 2019
(86) PCT No.: PCT/JP2019/041756

§ 371 Date: Apr. 23, 2021

(30) Foreign Application Priority Data
Oct. 25, 2018 (JP) 2018-200828

(51) Int. Cl. G02B 6/44; G02B 6/46; B65H 75/14

(52) U.S. Cl. CPC G02B 6/4457; G02B 6/46; B65H 2701/32; B65H 75/14; G02B 6/443

(57) ABSTRACT

Provided is an optical-fiber-cable winding bobbin 100 including: a body member 110 on which an optical fiber cable is wound; and a pair of flange members 120 that are provided at both ends of the body member 110, wherein the flange members 120 are made of ABS resin, and the body member 110 is made of a material having a smaller linear expansion coefficient than the flange members 120.

### TECHNICAL FIELD

The present disclosure relates to a bobbin.

The present application claims priority from Japanese Patent Application No. 2018-200828 filed on Oct. 25, 2018, the entire subject content of which is incorporated herein by reference.

### BACKGROUND ART

Commonly, a bobbin that is injection-molded using an acrylonitrile-butadiene-styrene (ABS) resin is known as a bobbin used for winding an optical fiber cable or the like (for example, see Patent Literature 1).

In addition, a bobbin made of a polyamide-based resin to which a glass filler is added is known as a bobbin that can be used even in an environment in which a temperature change is intense (for example, see Patent Literature 2).

### CITATION LIST

### Patent Literature

Patent Literature 1: JP-U-5-8505

Patent Literature 2: JP-A-2005-84236

### SUMMARY OF INVENTION

An optical-fiber-cable winding bobbin according to an aspect of the present disclosure includes a body member around which an optical fiber is wound, and a pair of flange members respectively provided at both ends of the body member, in which the flange member is made of an ABS resin, and the body member is made of a material having a linear expansion coefficient smaller than that of the flange member.

Here, the “optical fiber cable” refers to not only a normal cable form in which a cable core is covered with a sheath, but also a cable also including an optical fiber ribbon, and an optical unit obtained by twisting the optical fiber ribbon.

### BRIEF DESCRIPTION OF DRAWINGS

FIG. 1 is a perspective view of an optical-fiber-cable winding bobbin according to an embodiment of the present disclosure.

FIG. 2 is an exploded perspective view of the optical-fiber-cable winding bobbin according to the embodiment of the present disclosure.

FIG. 3 is a cross-sectional view taken along a line III-III in FIG. 1.

### DESCRIPTION OF EMBODIMENTS

<Problems to be Solved by Present Disclosure>

In the bobbin of Patent Literature 1, the ABS resin having a relatively high linear expansion coefficient is used in the synthetic resin. Therefore, the bobbin has strength, but the optical fiber cable may collapse due to the shrinkage of the bobbin when the bobbin is stored in an environment in which a temperature change is intense in a state in which the optical fiber cable is wound.

On the other hand, in the bobbin of Patent Literature 2, the body portion and the flange portion are also formed of a polyamide-based resin to which a glass filler is added, and a fluffy glass filler may damage the optical fiber cable from the polyamide-based resin.

In addition, since it is necessary to add a glass filler to a general resin, cost is also increased.

The present disclosure has been made in view of such circumstances, and an object of the present disclosure is to provide an optical-fiber-cable winding bobbin which achieves both prevention of winding collapse of an optical fiber cable caused by a change in temperature and prevention of damage to an optical fiber cable at low cost.

[Effects of Present Disclosure]

According to the present disclosure, it is possible to achieve both prevention of winding collapse of an optical fiber cable caused by a change in temperature and prevention of damage to an optical fiber cable at a low cost.

<Description of Embodiments of Present Disclosure>

First, the contents of embodiments of the present disclosure will be listed and described.

An optical-fiber-cable winding bobbin according to an aspect of the present disclosure includes: (1) a body member around which an optical fiber is wound, and a pair of flange members respectively provided at both ends of the body member, wherein the flange member is made of an ABS resin, and the body member is made of a material having a linear expansion coefficient smaller than that of the flange member.

Accordingly, since the shrinkage of the body member with respect to the change in temperature is prevented and a material having the same hardness as that of the material (glass) used in the optical fiber cable such as a glass fiber is not contained in the flange member, it is possible to achieve both prevention of winding collapse of the optical fiber cable caused by a change in temperature and prevention of damage to the optical fiber cable at low cost.

(2) In the above-mentioned optical-fiber-cable winding bobbin, a linear expansion coefficient of the body member is smaller than 100[×10⁻⁶/° C.].

As a result, it is possible to more reliably prevent winding collapse of the optical fiber cable caused by a change in temperature.

(3) In the above-mentioned optical-fiber-cable winding bobbin, the body member is made of an ABS resin containing glass fibers.

Only the body member is made of the ABS resin containing the glass fibers, the linear expansion coefficient decreases, so that the winding collapse of the optical fiber cable caused by a change in temperature can be prevented.

(4) In the above-mentioned optical-fiber-cable winding bobbin, the body member is made of an ABS resin containing talc.

Only the body member is made of the ABS resin containing talc, so that the linear expansion coefficient decreases. Therefore, the winding collapse of the optical fiber cable caused by a change in temperature can be prevented.

(5) In the above-described cable winding bobbin, a protective sheet is wound around a surface of the body member.

As a result, even if the glass fibers are fluffed on the surface of the body member, the fluffed glass fibers do not come into contact with the optical fiber cable. Therefore, the possibility that the optical fiber cable is scraped by the glass fibers can be prevented.

<Details of Embodiments of Present Disclosure>

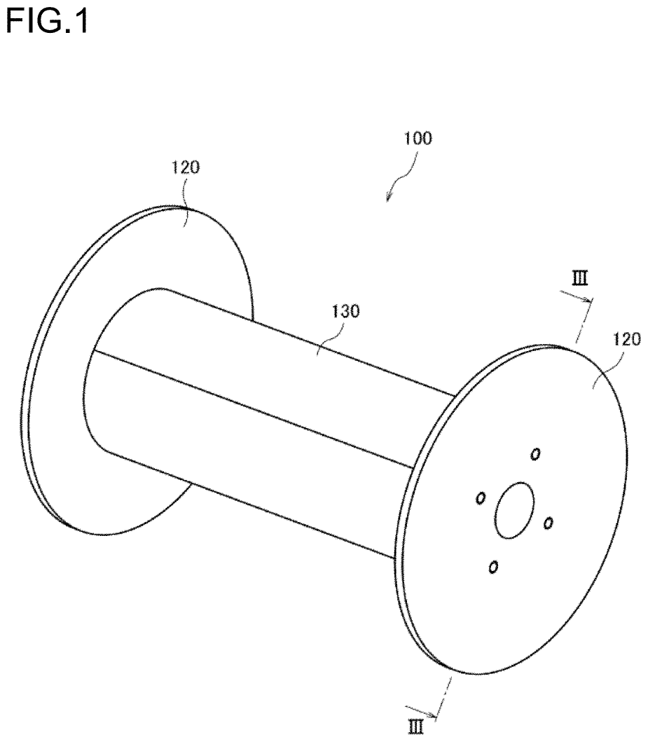

A specific example of an optical-fiber-cable winding bobbin according to an embodiment of the present disclosure will be described with reference to FIGS. 1 to 3.

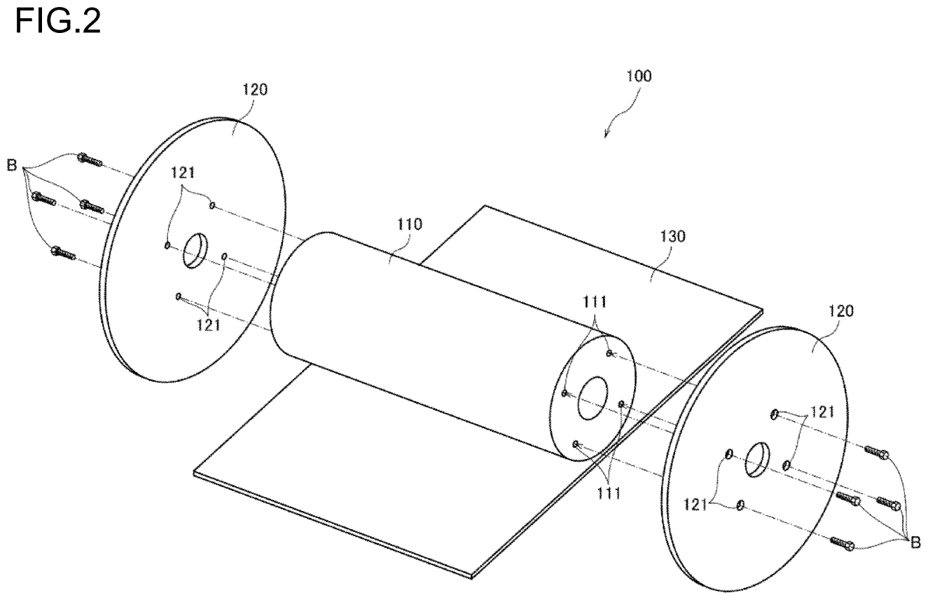

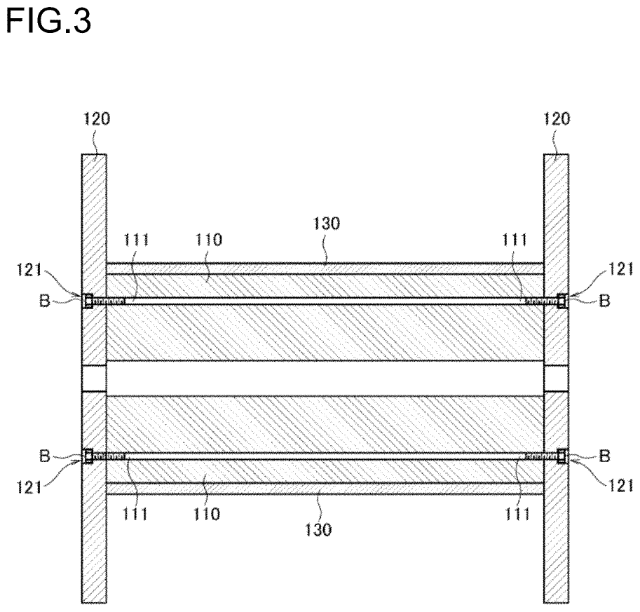

FIG. 1 is a perspective view of an optical-fiber-cable winding bobbin according to an embodiment of the present disclosure, FIG. 2 is an exploded perspective view of the optical-fiber-cable winding bobbin according to the embodiment of the present disclosure, and FIG. 3 is a cross-sectional view taken along a line III-III in FIG. 1.

Note that the present disclosure is not limited to these examples, and is defined by the scope of the claims, and is intended to include all modifications within the scope and meaning equivalent to the scope of the claims.

As shown in FIGS. 1 to 3, an optical-fiber-cable winding bobbin 100 according to an embodiment of the present disclosure includes a cylindrical body member 110, a pair of disc-shaped flange members 120 respectively provided at both ends of the body member 110, and a protective sheet 130 that is wound around the body member 110 and prevents contact between an optical fiber and the body member 110.

An optical fiber cable is wound around the body member 110 via the protective sheet 130.

The body member 110 is formed of an ABS resin containing glass fibers.

A linear expansion coefficient of the ABS resin containing the glass fibers is smaller than a linear expansion coefficient (100[×10⁻⁶/° C.]) of an ABS resin containing no glass fibers, and is, for example, 40[×10⁻⁶/° C.].

Four screw holes 111, for example, are formed on both end surfaces of the body member 110 in a longitudinal direction.

The flange members 120 are a pair of members respectively provided at both ends of the body member 110 in order to prevent the optical fiber cable wound around the body member 110 from falling off.

The flange member 120 is formed of an ABS resin having a linear expansion coefficient larger than that of the body member 110 (in other words, the body member 110 is formed of a material having a linear expansion coefficient smaller than that of the flange member 120).

In the flange member 120, for example, four through holes 121 penetrating in a thickness direction are formed.

A center of each of the through holes 121 coincides with a center of each of the screw holes 111 of the body member 110.

Using them, the body member 110 and the flange members 120 are fixed to each other by bolts B.

A width of the protective sheet 130 is substantially equal to a length of the body member 110 in a width direction (between the flange members 120).

The protective sheet 130 is formed of, for example, an ethylene-methyl methacrylate copolymer (EMMA) resin.

The optical-fiber-cable winding bobbin 100 includes the protective sheet 130, so that the protective sheet 130 is interposed between the optical fiber cable and the body member 110 when the optical fiber is wound around the optical-fiber-cable winding bobbin 100.

As a result, even if the glass fibers are fluffed on the surface of the body member 110, the fluffed glass fibers do not come into contact with the optical fiber cable. Therefore, the possibility that the optical fiber cable is scraped by the glass fibers is prevented.

Here, an optical-fiber-cable winding bobbin is generally required not to be damaged due to vibration during facility operation or transportation and not to shrink during a change in outside air temperature (in particular, shrinkage at a low temperature).

That is, the strength of the flange members is required in order to prevent the damage due to vibration during facility operation or transportation, and the linear expansion coefficient of the body member is required to be low in order to prevent shrinkage during the change of the outside air temperature (in particular, shrinkage at a low temperature).

Therefore, as in the optical-fiber-cable winding bobbin 100 according to the embodiment of the present disclosure, the body member 110 and the flange members 120 are formed of different materials, and the flange members are made of an ABS resin, and the body member is made of a material (an ABS resin containing glass fibers) having a linear expansion coefficient smaller than that of the flange members. Accordingly, the above-mentioned two requirements can be satisfied.

<Modification>

Although the embodiment of the present disclosure has been described above, the present disclosure is not limited thereto.

For example, the material of the body member 110 is not limited to the ABS resin containing glass fibers, and any material may be used as long as it has a linear expansion coefficient smaller than the linear expansion coefficient (100[×10⁻⁶/° C.]) of the flange members 120. For example, an ABS resin containing talc (a linear expansion coefficient: 70[×10⁻⁶/° C.]) may be used.

For example, the material of the protective sheet 130 may be one other than the EMMA resin.

Further, each element included in the above-described embodiment may be combined as long as technically possible, and a combination thereof is also included in the scope of the present disclosure as long as the features of the present disclosure are included.

### REFERENCE SIGNS LIST

100 Optical-fiber-cable winding bobbin

110 Body member

111 Screw hole

120 Flange member

121 Through hole

130 Protective sheet

B: Bolt

1. An optical-fiber-cable winding bobbin comprising:
a body member around which an optical fiber cable is to be wound; and
a pair of flange members respectively provided at both ends of the body member,
wherein the flange members are made of an ABS resin, and
the body member is made of a material having a linear expansion coefficient smaller than that of the flange members.

2. The optical-fiber-cable winding bobbin according to claim 1, wherein the linear expansion coefficient of the body member is smaller than 100[×10⁻⁶/° C.].

3. The optical-fiber-cable winding bobbin according to claim 1, wherein the body member is made of an ABS resin containing glass fibers.

4. The optical-fiber-cable winding bobbin according to claim 1, wherein the body member is made of an ABS resin containing talc.

5. The optical-fiber-cable winding bobbin according to claim 1, further comprising a protective sheet which is wound around a surface of the body member.
